(19) United States
(12) Patent Application Publication
(10) Pub. No.: US 2025/0306177 A1
(43) Pub. Date: Oct. 2, 2025

(54) LiDAR Transmitter with Flat Optics

(71) Applicant: OPSYS Tech Ltd., Holon (IL)

(72) Inventors: Yoo-Seung Lee, San Jose, CA (US); Larry Fabiny, Boulder, CO (US); Mark J. Donovan, Mountain View, CA (US)

(73) Assignee: OPSYS Tech Ltd., Holon (IL)

(21) Appl. No.: 19/082,809

(22) Filed: Mar. 18, 2025

Related U.S. Application Data
(60) Provisional application No. 63/569,983, filed on Mar. 26, 2024.

(51) Int. Cl. G01S 7/481

(52) U.S. Cl. CPC G01S 7/4815; G01S 7/4816

(57) ABSTRACT

A LiDAR transmitter includes a laser array comprising a plurality of lasers, each generating an optical beam at an output. A first transmission optic having a first focal length is positioned adjacent to the output of the laser array so that it projects the optical beams. A flat optic element is positioned between the output laser array and the first transmission optic and is configured to transform a shape of the optical beams generated by the plurality of lasers. A second transmission optic having a second focal length is positioned after the first transmission optical in the direction of propagation of the optical beams that projects the optical beams with the transformed shape onto a target plane, wherein the first focal length, the second focal length, and the transformed shape of the optical beams are configured to achieve a desired optical pattern at the target plane.

### RELATED APPLICATION SECTION

The present application is a non-provisional of U.S. Patent Provisional Patent Application No. 63/569,983, entitled “LiDAR Transmitter with Flat Optics”, filed on Mar. 26, 2024. The entire contents of U.S. Patent Provisional Patent Application No. 63/569,983 are herein incorporated by reference.

The section headings used herein are for organizational purposes only and should not be construed as limiting the subject matter described in the present application in any way.

### INTRODUCTION

Autonomous, self-driving, and semi-autonomous automobiles use a combination of different sensors and technologies such as radar, image-recognition cameras, and sonar for detection and location of surrounding objects. These sensors enable a host of improvements in driver safety including collision warning, automatic-emergency braking, lane-departure warning, lane-keeping assistance, adaptive cruise control, and piloted driving. Among these sensor technologies, Light Detection and Ranging (LiDAR) systems take a critical role in enabling real-time, high-resolution three-dimensional mapping of the surrounding environment.

More specifically, LiDAR is a remote-sensing technology that uses a laser beam for real-time measurement of distances in an environment. In a LiDAR system, laser light is sent out from a source (transmitter) and the laser light which reflects off objects in the field-of-view is detected by a receiver. The LiDAR system determines the distance to the object using time of flight or coherent detection methods. The LiDAR system also generates a three-dimensional point cloud by surveying the environment in a pointwise fashion, enabling the generation of detailed maps essential for many applications, from autonomous driving to topography.

### BRIEF DESCRIPTION OF THE DRAWINGS

The present teaching, in accordance with preferred and exemplary embodiments, together with further advantages thereof, is more particularly described in the following detailed description, taken in conjunction with the accompanying drawings. The skilled person in the art will understand that the drawings, described below, are for illustration purposes only. The drawings are not necessarily to scale; emphasis instead generally being placed upon illustrating principles of the teaching. The drawings are not intended to limit the scope of the Applicant's teaching in any way.

FIG. 1 illustrates a schematic diagram of a known solid-state LiDAR system.

FIG. 2 illustrates a two-dimensional vertical cavity surface emitting laser (VCSEL) array that can be used in a high-resolution LiDAR system of the present teaching.

FIG. 3A illustrates a transmit optical system for projecting optical beams from a laser array that uses two conventional bulk lenses.

FIG. 3B is an expanded view of a portion of the transmit optical system shown in FIG. 3A.

FIG. 3C illustrates a far field pattern generated by the transmit optical system for projecting optical beams from the laser array of FIG. 3A.

FIG. 4A illustrates a diagram of the spatial overlap of a laser sub-aperture pattern and a receiver detector pixel array in a common field of view.

FIG. 4B illustrates the resultant digital receive detection image associated with the diagram of the spatial overlap of the laser sub-aperture pattern of the receiver detector pixel array in the common field of view described in connection with FIG. 4A.

FIG. 5A shows spot divergence at three locations, Z1, Z2, and Z3 generated by a LiDAR transmitter with bulk optics configured at an optimal focus position, where the spot pattern propagates with little change in the ratio of spot size to spot spacing.

FIG. 5B shows spot divergence at three locations, Z1, Z2, and Z3 generated by a LiDAR transmitter with bulk optics configured in a defocus condition corresponding to spot overlap for all distances.

FIG. 5C shows spot divergence at three locations, Z1, Z2, and Z3 generated by a LiDAR transmitter with bulk optics configured in a defocus condition corresponding to a defocus condition where spots are tightly focused at a particular distance but unfocused at other distances.

FIG. 6A shows diffractive flat optics for use in LiDAR systems according to the present teaching comprising structures larger or significantly larger than the wavelength of light used in the system.

FIG. 6B shows meta-surface flat optics for use in LiDAR systems according to the present teaching that comprise structures with dimensions less than the wavelength of light used in the system.

FIG. 6C shows diffractive meta-surface flat optics for use in LiDAR systems that combine structures larger and smaller than the wavelength of light used in the system.

FIG. 7 illustrates a LiDAR transmitter according to one embodiment of the present teaching that uses a flat optic.

FIG. 8A shows a LiDAR system according to the present teaching with a flat optic element positioned in close proximity to a VCSEL so as to improve the non-uniformity of the beam projected by the conventional bulk lenses.

FIG. 8B illustrates a LiDAR transmitter with a light shaping diffuser using meta-surface flat optic technology according to the present teaching.

FIG. 9A illustrates an image of a far field pattern generated by a conventional LiDAR system without the use of flat optics showing the spatial overlap of a laser sub-aperture pattern and a receiver detector pixel array in a common field of view.

FIG. 9B illustrates an image of a far field pattern generated by a LiDAR system that uses flat optics to adjust the size and shape of the beams from each sub-aperture to increase the fill factor showing the spatial overlap of a laser sub-aperture pattern and a receiver detector pixel array in a common field of view.

FIG. 9C illustrates an image of a far field pattern generated by a LiDAR system that uses flat optics configured to broaden the beam shape and to transform it into split beams with a regular or random array showing the spatial overlap of a laser sub-aperture pattern and a receiver detector pixel array in a common field of view.

FIG. 10 illustrates a flow chart of the operation of a LiDAR system that uses flat optics according to the present teaching.

### DESCRIPTION OF VARIOUS EMBODIMENTS

The present teaching will now be described in more detail with reference to exemplary embodiments thereof as shown in the accompanying drawings. While the present teaching is described in conjunction with various embodiments and examples, it is not intended that the present teaching be limited to such embodiments. On the contrary, the present teaching encompasses various alternatives, modifications and equivalents, as will be appreciated by those of skill in the art. Those of ordinary skill in the art having access to the teaching herein will recognize additional implementations, modifications, and embodiments, as well as other fields of use, which are within the scope of the present disclosure as described herein.

Reference in the specification to “one embodiment” or “an embodiment” means that a particular feature, structure, or characteristic described in connection with the embodiment is included in at least one embodiment of the teaching. The appearances of the phrase “in one embodiment” in various places in the specification are not necessarily all referring to the same embodiment.

It should be understood that the individual steps of the method of the present teaching can be performed in any order and/or simultaneously as long as the teaching remains operable. Furthermore, it should be understood that the apparatus and method of the present teaching can include any number or all of the described embodiments as long as the teaching remains operable.

A LiDAR transmitter has at least one laser, a set of optical elements, and some means to electrically drive the laser. A LiDAR receiver has at least one detector which converts photons to an electrical signal, a set of optical elements, and some means to electrically operate the detector. LiDAR systems for autonomous vehicles are technically challenging to engineer as they need to be able to perform under a variety of environmental and driving conditions, including situations that include combinations of near and far distances of objects and various weather and ambient lighting conditions. It is important that the LiDAR system be able to provide accurate object size information. More particularly, the LiDAR system must obtain accurate range and image data in the form of a three-dimensional point cloud for a variety of different target sizes and shapes positioned at various distances, such as a highly reflective traffic cone a few meters away, as well as a dark non-reflective vehicle tire lying in the roadway, one hundred plus meters away.

Most commercially available LiDAR use some form of mechanical scanning to survey the environment in a pointwise fashion. It is highly desired to eliminate the mechanical scanning for improved reliability by using solid-state semiconductor-based LiDAR systems which has no moving elements, such as the systems manufactured by Opsys Tech Ltd., Holon, Israel, the assignee of the present application. LiDAR systems according to many embodiments of the present teaching are solid-state LiDAR systems that contain no moving parts. These LiDAR systems include a plurality of lasers, where each laser generates an optical beam with a single fixed projection angle. It should be understood that the use of solid-state lasers by itself does not mean that there are no moving parts. For example, Micro-Electromechanical Systems (MEMS) are often referred to as solid-state. However, MEMS used in LiDAR systems typically incorporate physical motion, which reduces the reliability and system lifetime.

The method for surveying the environment used by solid-state semiconductor-based LiDAR systems also influences the choice and design of the optical elements. In particular, the optical elements play a critical role in determining performance and physical size of the LiDAR system, which is critical to widespread adoption of these systems. Conventional optics, employing conventional bulk lenses and mirrors, tend to be relatively large compared to the other components in the LiDAR system. One aspect of the present teaching is the realization that flat optics, either conventional diffractive optics or meta optics, which use meta surfaces with sub-wavelength features, can be used to miniaturize the optics for use in solid-state semiconductor-based LiDAR systems.

In addition to miniaturization, flat optics that can include meta optics can be configured in systems to provide performance or functions that cannot be realized with conventional lenses or conventional diffractive optics. As one example, flat optics can be configured to transform the shape of the optical beams generated by the plurality of lasers to provide desired, performance-enhancing features in an optical pattern produced at a target range of the LiDAR system. However, flat optics can also bring some disadvantages, such as optical efficiency, which can be a significant challenge in engineering the system.

The present teaching relates to a solid-state light detection and ranging (LiDAR) system that includes transmitter optics utilizing flat optics, with diffractive and/or meta surfaces, positioned proximate to a laser array. The LiDAR system also includes a detector array. The transmitter optical system can be configured to optimize a combination of the LiDAR system performance for uniformity of received intensity, uniformity of range measurement, and/or uniformity of angular resolution across the field-of-view. Also, in some embodiments according to the present teaching, systems are configured to attain optimum performance and size using some combination of conventional optics and flat optics.

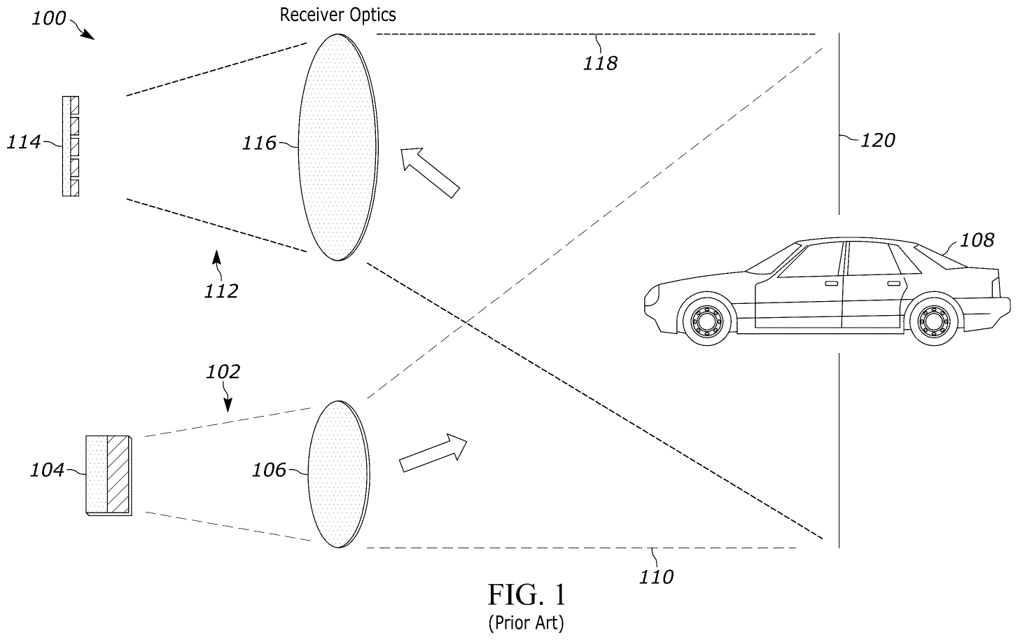

FIG. 1 illustrates a schematic diagram of a known solid-state LiDAR system 100. The system 100 includes a transmitter 102 comprising a plurality of lasers configured in a laser array 104 and transmitter optics 106 that shape the combined optical beam generated by the plurality of lasers. The transmitter optics 106 can be configured to generate an image from a plane in the transmitter, for example the plane of the laser array 104, at a target plane. Each laser or sub array of lasers within the laser array 104 can be operated independently and is referred to herein as a laser pixel. Each laser pixel generates a light beam with a corresponding three-dimensional projection angle subtending a portion of the total system field-of-view. Thus, each laser pixel when energized (also referred to as fired) generates an optical beam that illuminates a corresponding field-of-view at a target 108, which is shown in FIG. 1 as a vehicle. The total transmitter field-of-view 110 is a combination of the various energized laser pixel field-of-view.

The LiDAR system 100 illustrated in FIG. 1 includes a receiver 112 comprising a detector array having a plurality of detector pixels 114 and receiver optics 116. Each of the plurality of detector pixels 114 in the receiver 112 can be controlled such that individual or groups of detector pixels 114 are activated and detect light over a particular receiver field-of-view 118 at the target range 120. The total receiver field-of-view 118 represents the composite of all the detector pixel fields-of-view. The detector array can be positioned at an image plane of the target plane of the LiDAR transmitter as determined by the receiver optics 116.

One feature of the LiDAR system of the present teaching is that it can provide a compact, reliable transmit optical assembly for a high-resolution LiDAR system. Transmit optical assemblies of the present teaching utilize solid-state laser arrays. These solid-state laser arrays can be two-dimensional laser arrays that use a regular row and column configuration. The electrical control drive scheme can be configured in a so-called matrix configuration, where individual lasers can be addressed by appropriate application of an electrical control signal to a particular column and a particular row that contains that individual laser. See, for example, U.S. Pat. No. 11,320,538, entitled “Solid-State LiDAR Transmitter with Laser Control”, which is assigned to the present assignee and is incorporated herein by reference.

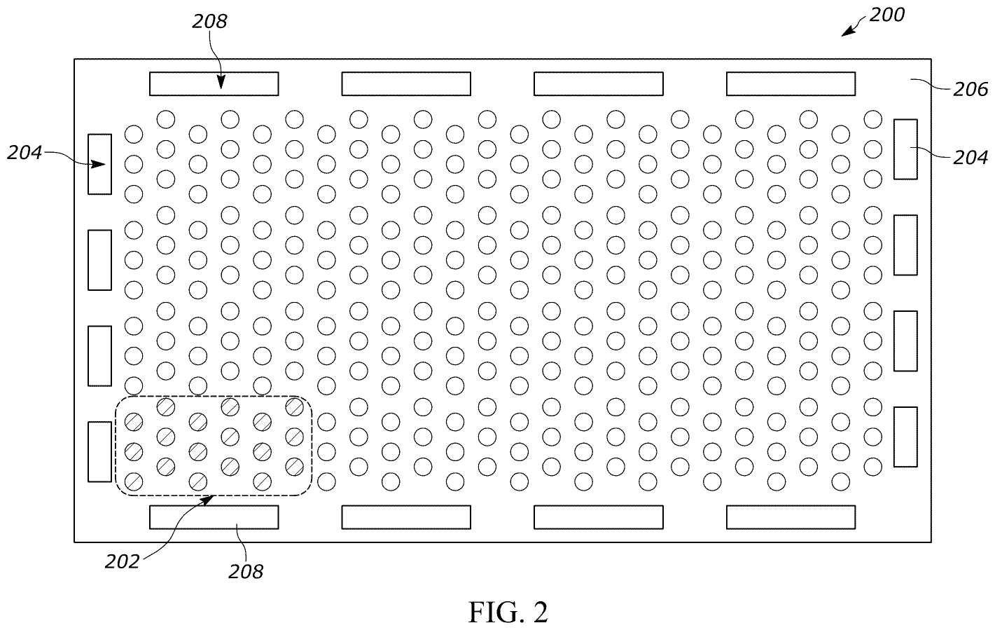

FIG. 2 illustrates a two-dimensional vertical cavity surface emitting laser (VCSEL) array 200 that can be used in a high-resolution LiDAR system of the present teaching. The laser array 200 includes a 4×4 array of individual laser pixels 202, where each pixel 202 incorporates a 3×6 array of sub-apertures. In some embodiments, each laser pixel 202 is addressable individually by applying the correct electrical control signal to a row and column corresponding to that laser pixel 202 in the laser array 200. In the configuration shown in FIG. 2, the anodes 204 are positioned on the left and right side of the die 206, while the cathodes 208 are positioned at the top and bottom of the die 206. With appropriate bias of the anodes 204 and cathodes 208, individual laser pixels 202 are energized independently, and all sub-apertures within one laser pixel 202 are energized together with the energization of the laser pixel 202. Thus, eighteen optical beams corresponding to eighteen sub-apertures are provided for each laser pixel 202 that is energized.

The laser array 200 has a laser pixel pitch in the x-direction and a laser pixel pitch in the y-direction. The laser pixel pitch in x and y direction are not necessarily the same, depending on the desired aspect ratio for the laser pixel 202. The number of laser pixels 202 and the number of sub-apertures in a laser pixel 202 in the laser array 200 differs in various embodiments. The array laser pixel pitch may take on different values in various embodiments. It should be understood that while the examples provided herein describe arrays of particular sizes, the present teaching is not limited to any particular array size. One feature of the present teaching is that the solid state, microfabricated components can easily scale to large sizes and are cost effective and have high reliability.

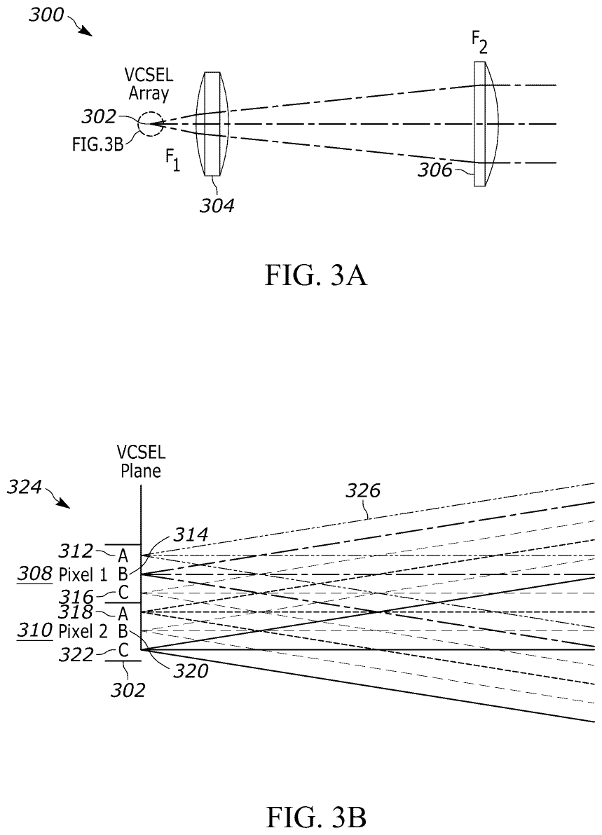

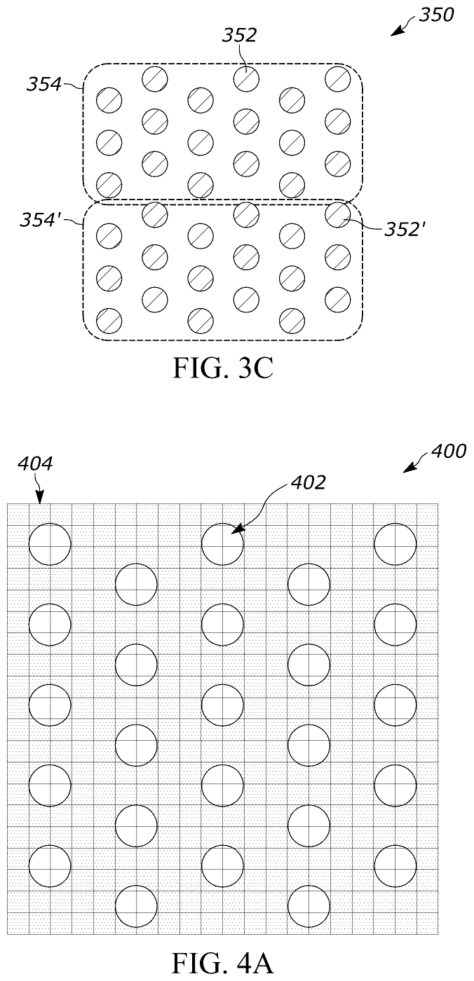

FIG. 3A illustrates a transmit optical system 300 for projecting optical beams from a laser array 302 that uses two conventional bulk lenses 304, 306 with respective focal lengths f1 and f2. The laser array 302 may be the same or similar to the laser array 200 described in connection with FIG. 2, as just one particular example.

FIG. 3B is an expanded view 324 of a portion of the transmit optical system 300 shown in FIG. 3A. The laser array 302 is shown in one dimension and includes individual pixels. Only two pixels are shown for simplicity, pixel 1 308 and pixel 2 310. The pixels 308, 310 each have sub-aperture arrays. The three sub-apertures A 312, B 314 and C 316 of pixel 1 308 and three sub-apertures A 318, B 320 and C 322 of pixel 2 310 are shown in one dimension. Optical beams 326 generated from each sub-aperture 312, 314, 316, 318, 320, 322 are emitted and diverge as shown in the expanded view 324. The divergence angle for each beam is related to the size of the respective sub-aperture.

Referring to both FIGS. 3A and 3B, the individual diverging optical beams 326 pass through a bulk lens 304 with the focal length, f1, which is positioned at a distance from the laser array 302 and a second bulk lens 306 with a focal length, f2, which is positioned at a distance from the first bulk lens 304. The positions of the lenses 304, 306 and their focal lengths f1, f2 determine a projected far field pattern of the transmit optical system 300. For this optical system, the two bulk lenses 304, 306 are configured to nominally generate an image of the laser array 302 in the far field. Thus, the laser array pattern is recreated in the far field and magnified to a desired size based on the lens configuration. The configuration includes the focal lengths, f1 and f2, of both lenses as well as their positions. The sub-apertures 312, 314, 316, 318, 320, 322 from individual pixels 308, 310 are separated in space. The angular field-of-view (FOV) of a beam emitted by each pixel 308, 310 is approximately the same as the angle spacing between pixels.

FIG. 3C illustrates a far field pattern 350 generated by the transmit optical system 300 for projecting optical beams from the laser array 302 as described in connection with FIG. 3A. Far field spots 352, 352′ from sub-apertures are shown for two vertically adjacent pixels 354, 354′, where each pixel comprises a 3×6 array of sub-apertures. The far field pattern 350 includes eighteen individual spots for each pixel region 354, 354′.

Various detector technologies can be used for the detector array, for example detector array 114 of LiDAR system 100 described in connection with FIG. 1. For example, Single Photon Avalanche Diode Detector (SPAD) arrays, Avalanche Photodetector (APD) arrays, and Silicon Photomultiplier Arrays (SPAs) can be used. Detector arrays comprise a plurality of detector pixels. The detector pixel size defines the resolution by setting the FOV of a single detector pixel, and also determines the response time and detection sensitivity of each pixel.

In LiDAR systems according to the present teaching, the number of laser pixels and the number of detector pixels are typically not the same. In many embodiments of LiDAR systems according to the present teaching, the detector arrays typically have many more detector pixels than the laser array has laser pixels. Similar to detector arrays commonly used in CMOS cameras, the detector array in a LiDAR system using a SPAD array might have millions of individual detector pixels, where each individual pixel is typically less than 10 microns in size. A typical two-dimensional VCSEL laser array might only have a few hundred laser pixels, because of the current practical limitations associated with the fabrication and electrical operation of the VCSEL. For example, the aperture size of a VCSEL laser strongly influences the optical performance and reliability of the laser, and cannot be set arbitrarily. This aspect of VCSEL technology is one reason why the ability to transform the shape of the optical beams generated by the VCSEL lasers by using flat optical elements in the transmitter provides additional features to LiDAR system design. VCSELs in common use today for high optical power applications such as LiDAR, and which are fabricated using oxide confinement structures, typically have aperture sizes of about 20 to 40 microns in size. For a laser array utilizing laser pixels with multiple sub-apertures, the total number of sub-apertures for the full array would be on the order of a few thousand, which is much less than the expected number of detector pixels. However, it should be understood that LiDAR systems according to the present teachings are not limited transmitters that use currently available VCSEL devices. It is anticipated that larger and higher performing VCSEL devices will be available in the near future.

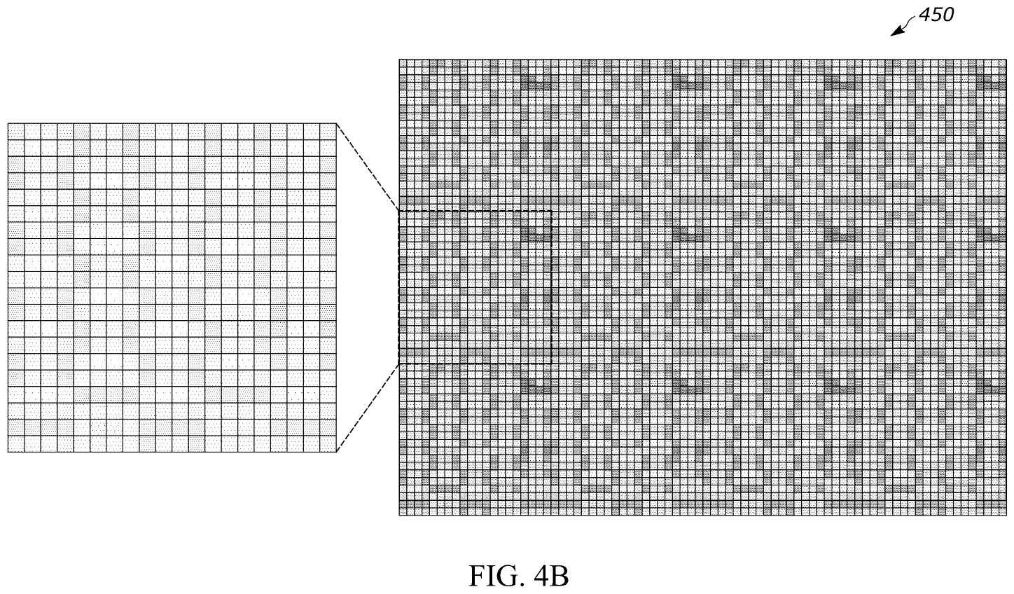

FIG. 4A illustrates a diagram 400 of the spatial overlap of a laser sub-aperture pattern and a receiver detector pixel array in a common field of view. In particular, the diagram 400 shows an image of laser sub-apertures 402 representing one possible configuration where the number of laser sub-aperture 402 is substantially less than the number of detector pixels 404. Each detector pixel 404 is represented as one small square in the image. Each laser sub-aperture 402 is represented as a circle projected onto the detector array. One can define a ‘fill factor’, which is equal to the combined area of the laser sub-apertures 402 divided by the corresponding total area of the detector in the projected view. For example, in FIG. 4A, the laser sub-aperture fill-factor is ˜25% of the detector area.

FIG. 4B illustrates the resultant digital receive detection image associated with the diagram 400 of the spatial overlap of the laser sub-aperture pattern of the receiver detector pixel array in the common field of view described in connection with FIG. 4A. In particular, FIG. 4B shows a digital image 450 that illustrates how the received digital image would typically appear corresponding to the example shown in FIG. 4A. In this digital image 450, each detector pixel has a particular peak received intensity shown in gray scale, which could correspond, for example, to a count of the number of photons received within some time period. A substantial number of detector pixels in FIG. 4B are black, which indicates a low level of intensity (received photons). Pixels which have low or no received peak received intensity level cannot provide sufficient electrical signal for measurement of the TOF (range), and so these points will be absent in the generated three-dimensional point cloud. In LiDAR systems according to the present invention, the measurement range is dependent on the peak power (energy) of the received signal.

FIG. 4A and FIG. 4B illustrate one common limitation that arises when the number of detector pixels is greater than the number of VCSEL sub-apertures. The effective resolution of the LiDAR system in this case is not the full resolution of the SPAD detector array because there are portions of the array which have no illumination, and thus present no information.

In order to overcome the resolution limitations described by FIG. 4A and 4B, the fill-factor of the VCSEL array transmitter pattern projected onto the detector array must be increased in some fashion. One way of increasing the fill-factor is to increase the number of sub-apertures in the VCSEL, but there are physical and performance limitations in the construction of the VCSEL that will limit the number, size, and distance between sub-apertures.

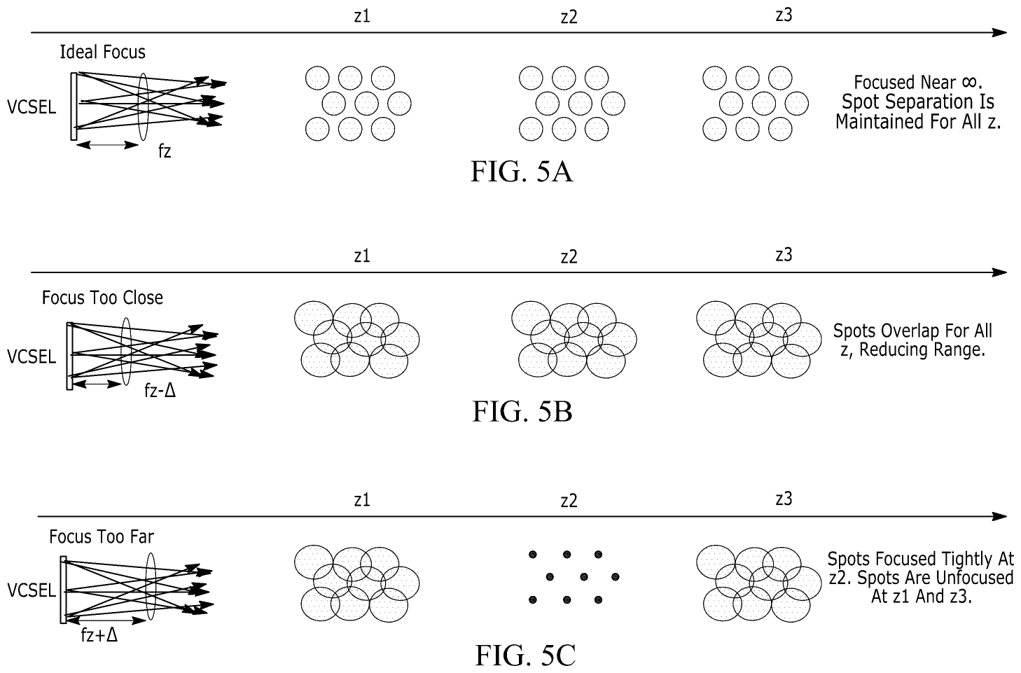

Another way of increasing the transmitter fill factor to increase resolution is to defocus the optical system, essentially ‘blurring’ the projected pattern. FIGS. 5A-C show examples illustrating the consequences of defocusing the transmitter lens in a system similar to FIG. 3A in order to “blur” the individual laser spots by changing the beam divergence angle. The “blurring” effectively widens the individual laser spots. This “blurring” is one example of a shape transformation of an optical laser beam.

FIGS. 5A-5C illustrate spot divergence generated by three different LiDAR transmitters using conventional bulk optics for three different distances. These figures show the effect of focus on spot divergence. FIG. 5A shows spot divergence at three locations, Z1, Z2, and Z3 generated by a LiDAR transmitter with bulk optics configured at an optimal focus position, where the spot pattern propagates with little change in the ratio of spot size to spot spacing. This optical focus configuration corresponds to a focus near infinity where spot separation is maintained over all distances.

FIGS. 5B and 5C show optical configurations of LiDAR transmitters where the spot pattern varies more with target distance than the optical focus position case shown in FIG. 5A. FIG. 5B shows spot divergence at three locations, Z1, Z2, and Z3 generated by a LiDAR transmitter with bulk optics configured in a defocus condition corresponding to spot overlap for all distances. This condition reduces the range of the LiDAR system.

FIG. 5C shows spot divergence at three locations, Z1, Z2, and Z3 generated by a LiDAR transmitter with bulk optics configured in a defocus condition corresponding to a defocus condition where spots are tightly focused at a particular distance but unfocused at other distances.

One aspect of the present teaching is the realization that a LiDAR transmitter can be configured with optics that generate defocus conditions similar to those shown in connection with FIGS. 5B and 5C that can be configured so that the spot sizes are increased by an ideal amount to fill in the gaps between spots. However, it is difficult or impossible to generate such defocus conditions with conventional optics. Conventional optics can only generate ideal defocus condition over a narrow range of target distances, with the amount of defocus defining the distance to the ideal defocus or blurring. The spot overlap before and after this distance will either be too small or too large, with the errors increasing as the target distance changes. Too much overlap reduces the optical power in the receiver pixel, while too little overlap creates gaps where smaller targets may be missed. LiDAR transmitter lens system using conventional bulk optics are limited in the ability to change the imaged spot size of the sub-aperture. In particular, conventional LiDAR transmitter lens systems cannot produce a uniform increase in the spot size at all distances by using focus changes. However, a shape transformation using a flat optic element can achieve this kind of uniform increase and/or an increase of spot size over a larger range of target distances as compared to conventional LiDAR transmitter lens systems.

Another aspect of the present teaching is that flat optic technology can be used instead of conventional bulk optic elements to improve performance of LiDAR systems. Conventional bulk optic or traditional optics are based on the refraction and reflection of light in optical elements whose dimensions are significantly larger than the wavelengths of light they process. A distinguishing feature of flat optics is the use of arrays that are either micro-scale elements and/or nanoscale elements that are smaller than the wavelength of light they process. In aggregate, these micro-scale and nanoscale elements can bend and manipulate light to mimic the functionalities of traditional optics, but importantly, can also give rise to some completely new capabilities. In particular, flat optical elements according to the present teaching can be configured to diffuse and/or shape light in various ways.

In one aspect of the present teaching, flat optics are used to realize a defocus that improves performance metrics and even can be used to optimize performance metrics. In various embodiments, flat optics can be manufactured in thin film form which allows for significant improvements in size, cost, and mass production capabilities. In particular, the precise design and fabrication used to create flat optic elements is highly suitable for improving the non-uniformity of LiDAR images. The technologies for producing these flat optic elements can be mainly categorized into three types: Diffractive Flat Optics (DFO); Meta-Surface Flat Optics (MSFO); and Diffractive Meta-Surface Flat Optics (DMSFO).

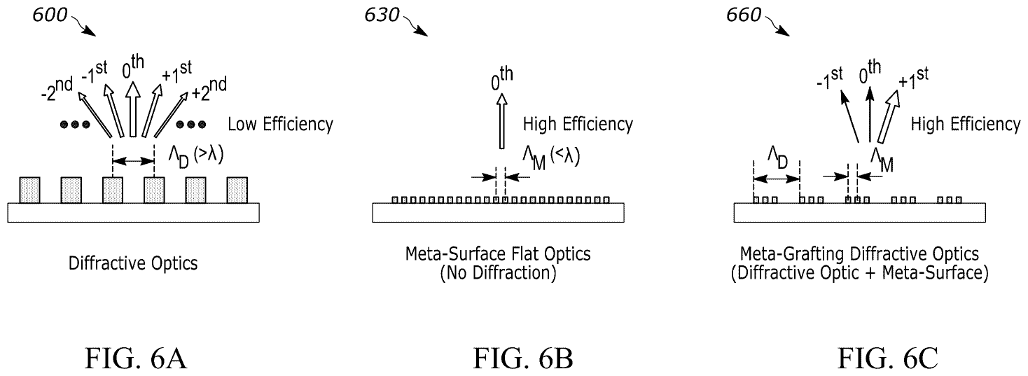

FIGS. 6A-C show diagrams illustrating three types of flat optic configurations using simple two-dimensional diagrams. The key distinction among these three types of flat optics is the size of the designed structures and the periodicity of the structures with respect to the wavelength of light.

FIG. 6A shows diffractive flat optics 600 for use in LiDAR systems according to the present teaching comprising structures larger or significantly larger than the wavelength of light used in the system. The diffractive flat optics shown in FIG. 6A can be classified into two main types. One type of diffractive flat optics 600 uses grating patterns and also utilizes hologram patterns. The grating patterns comprise either regular periodic structures or pseudo-random/non-periodic structures. Another type of diffractive flat optics 600 uses light shaping diffusers. These diffusers are sometimes called engineered diffusers. In some embodiments, these diffusers are configured to control the divergence of the diffused beam for enhanced efficiency. These diffusers often adopt pseudo-random or non-periodic structures. The sizes of the structures are typically in the range of 50 to 100 um, with a minimum size of at least 10 microns in order to provide the desired diffraction pattern. This makes the sizes of the structures relatively large compared to the wavelength of the laser. The transmission intensity efficiency is generally around 90%, and when the diffractive flat optics 600 are produced using commonly applied polymers, issues such as temperature stability and long-term stability may arise.

FIG. 6B shows meta-surface flat optics 630 for use in LiDAR systems according to the present teaching that comprise structures with dimensions less than the wavelength of light used in the system. The meta-surface flat optics 630 shown in connection with FIG. 6B are structured as arrays of meta-atoms in one-dimensional, two-dimensional, and three-dimensional configurations, with the spacing and size of meta atoms being sub-wavelength. This configuration creates a homogeneous medium that avoids diffraction. By controlling optical properties, such as the phase, intensity, and polarization of light passing through each meta-atom, it becomes possible to create an optical element with the desired optical properties for a LiDAR system. Furthermore, by designing meta-atoms with spatial variations, it becomes possible to tailor optical characteristics even with a few micrometers of spatial difference. That is, the meta-atom size and spatial variations can be configured to produce a desired transformation of an optical beam shape emitted from a laser array to produce a desired beam pattern at a target range of a LiDAR.

One aspect of the present teaching is the determination that meta-surface flat optics 630 having patterns of meta-atoms with feature sizes that are sub-wavelength are particularly suitable for use in LiDAR transmitters. One reason is because conventional diffractive flat optic elements may experience diffraction loss that limit the transmission intensity to around 90%, and meta-surface flat optics do not experience that same diffraction loss. Also, the relatively large feature sizes in the range of 50 to 100 micrometers that are used in conventional flat optic elements can lead to increased optical speckle, which degrades the quality of the image. For example, meta-surface flat optics 630, which are not diffraction based, can achieve over 95% transmission intensity with relatively low speckle. These features make meta-surface flat optics 630 more suitable for implementing optical elements in LiDAR systems.

Also, with conventional diffractive flat optic elements, the range of possible diffuse angles is particularly sensitive to the angle of the incident beam because the structure element sizes are relatively large, on the order of hundreds of micrometers. In contrast, with meta-surface flat optics diffusers 630 that are not diffractive, the structure element sizes ranging from tens to hundreds of nanometers allow for use of spatially different diffuse angles. This capability enables the fabrication of diffusers that can be closely applied to laser apertures of several micrometers in size. It is understood that the optical characteristics, such as angle and efficiency of light, of meta surfaces may vary based on the shape and size of the structures. However, state-of-the art manufacturing techniques can be used to control variation that impact yield in mass production.

FIG. 6C shows diffractive meta-surface flat optics 660 for use in LiDAR systems according to the present teaching comprising a combination of structures larger and smaller than the wavelength of light used in the system. Diffractive meta-surface flat optics 660 comprising a combination of structures larger and smaller than the wavelength of light used for illumination represents a hybrid technology that combines conventional diffraction techniques with meta-surface technology. One feature of this approach is that these so-called diffractive meta-surface flat optics 660 can comprise large periodicities structures that induce diffraction as well as meta-structures with asymmetric shapes and smaller periodicities that can be used to transform the diffracted wave. This hybrid structure allows for improved or optimized efficiency for certain diffraction modes. Also, these structures can achieve an optical efficiency that is over 95% for some diffraction modes.

Similar to conventional diffractive flat optics, diffractive meta-surface flat optics 660 can experience optical characteristic variations due to the fabrication process variations. However, state-of-the-art fabrication techniques can be used to minimize these variations. The transmission efficiency of diffractive meta-surface optics 660 falls somewhere between that of diffractive optics and meta-surface optics. Thus, another aspect of the present teaching is that diffractive meta-surface flat optics 660 leveraging a hybrid approach to maximize efficiency for specific diffraction modes, combines the advantages of both conventional diffraction and meta-surface technologies.

In various configurations of LiDAR systems according to the present teaching, the use of flat optic technology can provide performance, size, cost, and production advantages. As an example, the use of flat optics in LiDAR systems can be used to advantageously address the non-uniformity challenges in LiDAR imaging within a compact, low-cost package.

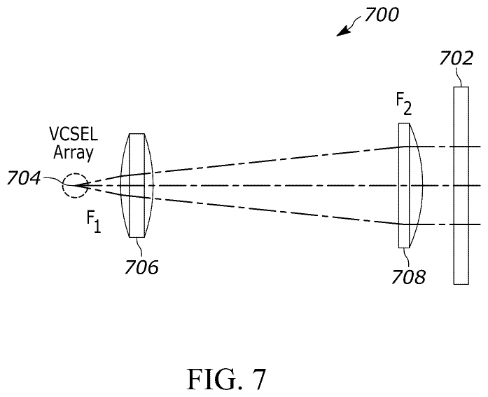

FIG. 7 illustrates a LiDAR transmitter 700 according to one embodiment of the present teaching that uses a flat optic 702. The LiDAR transmitter 700 is similar to the LiDAR transmitter 300 described in connection with FIG. 3A, however the flat optic 702 is included. The LiDAR transmitter 700 includes a laser array, such as a VCSEL array 704 that generates light beams. The LiDAR transmitter 700 also includes a transmit optical system comprising first and second transmit optics that include at least two conventional bulk lenses 706, 708 with respective focal lengths f1 and f2 that projects optical beams from the laser array 704. In other embodiments, the transmit optics can include more than one bulk optical element. The laser array 704 may be the same or similar to the laser array 200 described in connection with FIG. 2, as just one particular example. The flat optic 702 is positioned at the output of the second conventional bulk lenses 708 with the focal length f2 in the direction of beam propagation.

The flat optic 702 can be configured as a diffractive optic, a meta-material, or a diffuser that increases the divergence angles of all beams by a desired amount. One engineering challenge in placing the flat optic at the output of the lens system is that the size of the element must be sufficiently large to capture all the light. Also, the position after output lens 708 is the location within the lens with the largest beam diameters. Using a relatively large flat optic increases complexity and cost of making the flat optic. However, new technologies are increasingly making it easier and more cost effective to fabricate relatively large flat optic devices.

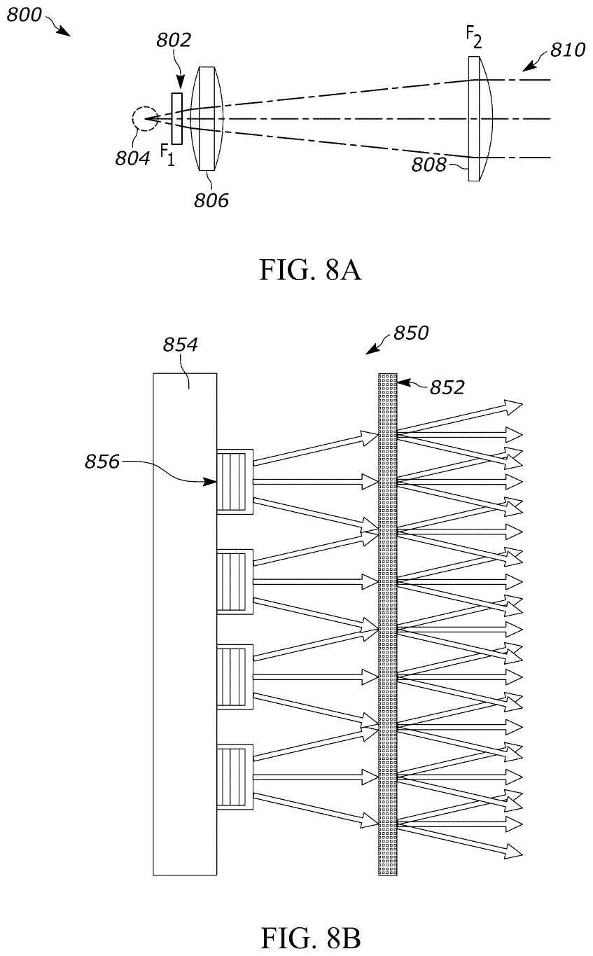

FIG. 8A shows a LiDAR system 800 according to another embodiment of the present teaching with a flat optic element 802 positioned in close proximity to a laser array 804. The LiDAR transmitter 800 is similar to the LiDAR transmitter 300 described in connection with FIG. 3A and the LiDAR transmitter 700 described in connection with FIG. 7. The LiDAR transmitter 800 includes a laser array 804, such as a VCSEL array, that generates light beams. The LiDAR transmitter 800 also includes a transmit optical system comprising first and second transmit optics that include at least two conventional bulk lenses 806, 808 with respective focal lengths f1 and f2 that projects optical beams from the laser array 804. In other embodiments, the transmit optics can include more than one bulk optical element. The combination of the focal lengths, or effective focal lengths for multiple bulk lenses, of the transmission optics (here shown as lenses 806, 808) and the transformation properties of the flat optic element 802 determine the optical pattern provided at one or more target ranges of the LiDAR system 800. The laser array 804 may be the same or similar to the laser array 200 described in connection with FIG. 2, as just one particular example.

The flat optic 802 is positioned in close proximity to a laser array 804 so as to provide non-uniformity of the optical beam projected by the conventional bulk lenses 806, 808. In this configuration, the object plane is essentially translated to the position of the flat optic. Translating the focal position of the transmission lens 806 from the VCSEL array 804 surface to the flat optic element 802 surface modifies the beam profile or shape from the VCSEL 804 surface to be projected through the transmission lens 808. This configuration improves the non-uniformity of the modified beam 810 provided at the output of the LiDAR transmitter 800.

FIG. 8B illustrates a portion of a LiDAR transmitter 850 with a light shaping diffuser 852 using meta-surface flat optic technology according to the present teaching. The LiDAR transmitter 850 shows an expanded view of the laser array, which shows one pixel of a VCSEL array 854 with four sub-apertures 856. The light shaping diffuser 852 using meta-surface flat optic technology is positioned in close proximity to the output of the VCSEL array 854. The light shaping diffuser 852 is configured to scatter the incident light, making the starting point of the beam appear to be at the surface of the diffuser 852 from the perspective of a transmission lens (not shown in FIG. 8B), such as the transmission lens 806 described in connection with FIG. 8A. In various embodiments, the light shaping diffuser 852 can be configured to have a specific desired beam divergence.

A LiDAR system using a conventional diffuser will have the angle of the incoming light to the diffuser and the angle of output scattering vary based on the position due to the beam divergence of the VCSEL array 804. In contrast, a LiDAR system using the meta-surface diffuser, as shown in FIG. 8B, can be configured to scatter differently based on the spatially varying angles of incident light so that the final output light beam can be designed to scatter uniformly across different positions.

Thus, a LiDAR system with an optical system that uses flat optics according to the present invention addresses the limitations of LiDAR systems that use conventional bulk optical system sufficiently to allow improved optical intensity profiles across a much wider range of distances, and across a wider field-of-view than conventional LiDAR systems. LiDAR systems according to the present teaching substantially overcome limitations of known LiDAR systems that suffer from non-optimal focus quality across distance, and also suffer from focus variation across target illumination the field of view.

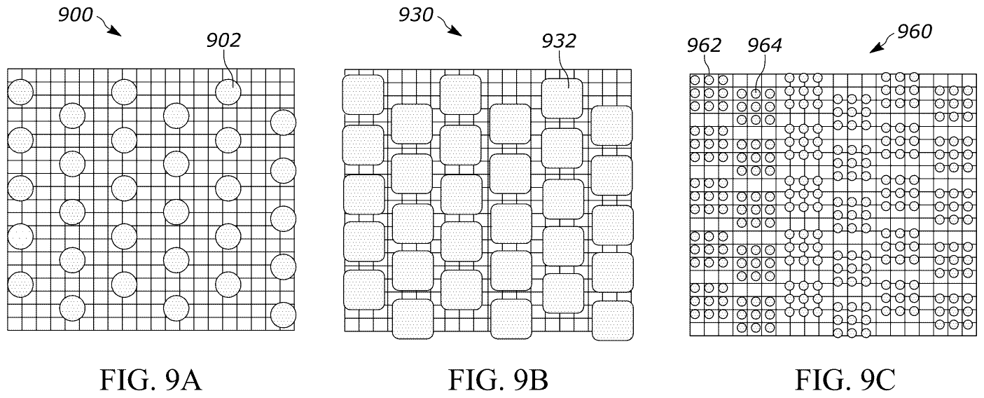

FIGS. 9A-C presents examples of far field patterns generated by LiDAR systems that include flat optics 930, 960 according to the present teaching compared to examples of far field patterns produced with a conventional bulk lens optical system 900. FIG. 9A presents an image of a far field pattern 900 generated by a conventional LiDAR system without the use of flat optics showing the spatial overlap of a laser sub-aperture pattern and a receiver detector pixel array in a common field of view. The far field pattern 900 illustrates the sub-aperture array of the unit VCSEL as a filled circle 902.

FIG. 9B presents an image of a far field pattern 930 generated by a LiDAR system that uses flat optics to adjust the size and shape of the beams from each sub-aperture to increase the fill factor showing the spatial overlap of a laser sub-aperture pattern and a receiver detector pixel array in a common field of view. The far field pattern 930 illustrates the pixel array of the receiver sensor for the matching field empty square. FIG. 9B shows how flat optics can be used in LiDAR systems to adjust the size and shape of the beams 932 from each sub-aperture in order to increase the fill factor to a desired number.

More specifically, FIG. 9B illustrates how the beam 932 from each sub-aperture can be uniformly expanded into a specific shape, such as a circle, square, or hexagon. In the example, shown in FIG. 9B, the sub-aperture is uniformly expanded into a square shape beam 932. This expansion of the beam 932 into a square shape can dramatically improve the non-uniformity of the detected image at the receiver sensor.

It should be understood that the amount of light entering the square unit pixel of a sub-aperture beam 932 decreases due to the broadening of the beam. This decrease in the amount of light entering the square unit pixel can result in some decrease in performance, such as a decrease in detection distance range or a reduction in signal-to-noise ratio. The amount of possible decrease in detection distance range or reduction in signal-to-noise ratio depends on the receiver design and on characteristics of the receiver sensor, such as detection threshold level or nonlinear sensitivity.

FIG. 9C presents an image of a far field pattern 960 generated by a LiDAR system that uses flat optics configured to broaden the beam shape and to transform it into split beams 962, 964 with a regular or random array showing the spatial overlap of a laser sub-aperture pattern and a receiver detector pixel array in a common field of view. In this example, each sub-aperture beam is split into nine beams. Using flat optics in this configuration, the image at the receiver can become sufficiently uniform when the spacing between the split beams is equal to or smaller than the pitch of the receiver pixels. In addition, by splitting the beam, it is possible to increase the peak intensity of the split beams, mitigating the degradation of detection distance and SNR characteristics caused by the broadening of the beam at the receiver sensor. In some embodiments, the coherence characteristics of VCSEL lasers can be utilized to control speckle patterns to improve performance in this configuration.

It should be understood that although the flat optic configurations that are used to generate the far field patterns presented in FIG. 9B and FIG. 9C are shown in these particular examples as uniform patterns, flat optics according to the present teaching can be configured to produce non-uniform patterns, even random or pseudo-random patterns.

Additionally, coherent properties of lasers can lead to speckle patterns when the beam is expanded. Therefore, when applying flat optics to lasers, it is essential to consider the design characteristics of lasers and customize flat optics accordingly. This involves designing flat optics specifically tailored to the characteristics of the laser being used with the flat optics.

Thus, one feature of the LiDAR systems of the present teaching is that flat optic can be specifically designed and configured to improve the non-uniformity of LiDAR images. The configuration of the flat optics depends on many factors, such as the type of laser (i.e., conventional laser diode, VCSEL, etc.), the type of laser drive, (i.e., CW or pulse), the emission wavelength, the emission linewidth, the initial beam profile, the emission mode, the coherence length, speckle, and other relevant parameters. In particular, the initial beam profile and emission mode are crucial for determining the flat optic element configuration. Coherence length and speckle can impact the quality of the images. The laser arrays can also be specifically designed with a coherence length and optical phase properties that reduce speckle and that achieve a desired image quality. As such, some embodiments of LiDAR transmitters of the present teaching utilize a laser array having a coherence length that is configured to reduce speckle from a flat optic element in the transmitter.

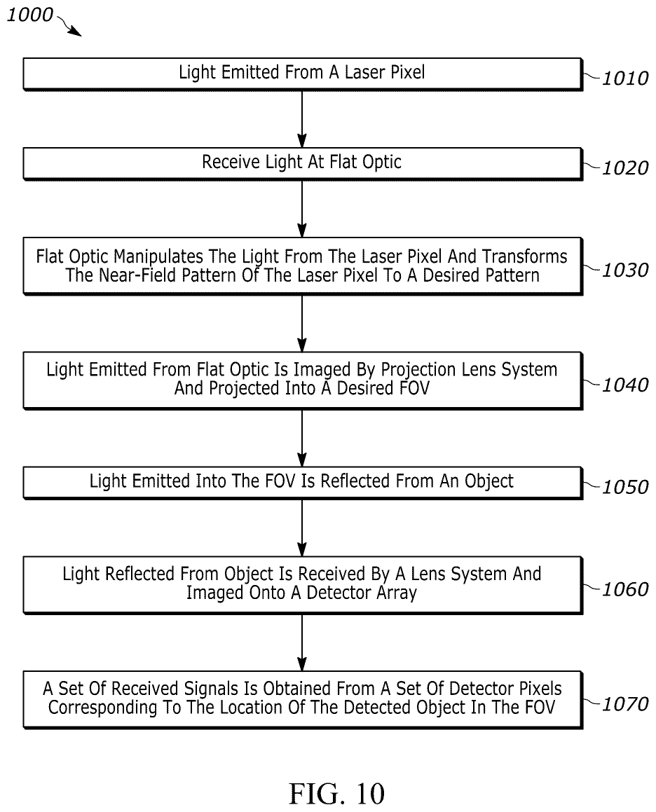

FIG. 10 illustrates a flow chart 1000 of the operation of a LiDAR system that uses flat optics according to the present teaching. In a first step 1010, light is emitted from a laser pixel. In a second step 1020, the light emitted from the laser pixel is received at a flat optic in an optical system. For example, the flat optics described in connection with FIG. 8A and 8B can be used. In a third step 1030, the flat optics performs a transform of the near-field pattern manipulating the light from the laser pixel to have a desired pattern. For example, some desired light patterns are described in connection with the description associated with FIGS. 9A-C. One example is that the flat optics can broaden each beam at each of a large range of output locations from the transmitter. Another example is that the flat optics can produce beam patterns so as to improve a fill-factor of the beams on a detector array. Another example is that the flat optic can split a beam into multiple beams in various patterns such that a spacing between the split beams is equal to or smaller than the pitch of the receiver pixels. In some embodiments of LiDAR systems according to the present teaching more than one of these example features are provided by the flat optic.

In a fourth step 1040, the transformed light emitted from the flat optic is received by a project lens system that images the light into a desired far field. The emission surface of the flat optic is near to the image plane of the projection lens system. In a fifth step 1050, light from the projection lens system propagates into the field of view and then is reflected from an object to be detected. In a sixth step 1060, light is reflected from the object present in the desired field of view and is received by a receiver lens system. For example, the receiver lens system described in connection with FIG. 1 can be used. In a seventh step 1070, a set of received signals is obtained from a set of detector pixels in the detector that correspond to the location of the detected object in the desired field of view.

It should be understood that the present teaching can be used to apply flat optics to Light Emitting Diode (LED) technology. However, applying the flat optic technology to LED arrays is not a straight forward extension of the application of flat optics to laser arrays because LEDs do not have resonant cavity structures. Consequently, light emitted from the LEDs has a broad spectrum and diverges in random directions based on the energy bandgap of the semiconductor material used to fabricate the LED. In particular, the optical emission beam divergence of LEDs is much wider compared to the optical emission beam divergence generated by lasers. Precise control of beam shape generated by LEDs with a single flat optic is more difficult to accurately achieve. There can be significant optical losses at wider divergence angles. In contrast, lasers can generate narrowband wavelengths based on the design of their cavity structure, and beam shape and divergence can be controlled through the laser design.

Thus, a feature of the present teaching is the recognition that a flat optic can be used in a LiDAR transmitter such that a beam pattern emerging from an array of laser devices in the transmitter is better matched to a receiver detector pixel array in the LiDAR system as compared to a LiDAR transmitter without a flat optic. This better match has numerous advantages. For example, the better match can provide a more optimal fill factor of the detector array. This better match can also improve detector signal-to-noise ratio. The better match can also reduce gaps in a field of view of the LiDAR system. The better match can also reduce a sensitivity to spatially varying angles of incident light to the transmit optics so that the final output light beam can be designed to scatter uniformly across different positions, thereby supporting a wider field of view.

### Equivalents

While the Applicant's teaching is described in conjunction with various embodiments, it is not intended that the Applicant's teaching be limited to such embodiments. On the contrary, the Applicant's teaching encompasses various alternatives, modifications, and equivalents, as will be appreciated by those of skill in the art, which may be made therein without departing from the spirit and scope of the teaching.

What is claimed is:

1. A light detection and ranging transmitter comprising:
a) a laser array comprising a plurality of lasers, each of the plurality of lasers generating an optical beam at an output of the laser array;
b) a first transmission optic having a first focal length and being positioned adjacent to the output of the laser array, the first transmission optic projecting the optical beams generated by the laser array;
c) a flat optic element positioned between the output laser array and the first transmission optic, wherein the flat optic element is configured to transform a shape of the optical beams generated by the plurality of lasers; and
d) a second transmission optic having a second focal length and being positioned after the first transmission optical in a direction of propagation of the optical beams, the second transmission optic projecting the optical beams with the transformed shape onto a target plane, wherein the first focal length, the second focal length, and the transformed shape of the optical beams are configured to achieve a desired optical pattern at the target plane.

2. The light detection and ranging transmitter of claim 1, wherein the laser array comprises a vertical cavity surface emitting laser.

3. The light detection and ranging transmitter of claim 1, wherein the laser array comprises a two-dimensional vertical cavity surface emitting laser.

4. The light detection and ranging transmitter of claim 1, wherein the flat optic element comprises a meta-surface flat optic.

5. The light detection and ranging transmitter of claim 1, wherein the flat optic element comprises a diffractive meta-surface flat optic.

6. The light detection and ranging transmitter of claim 5, wherein the diffractive meta-surface flat optic comprises a first periodic structure having features greater than a wavelength of light illuminating the first periodic structure and a second periodic structure having features less than a wavelength of light illuminating the second periodic structures.

7. The light detection and ranging transmitter of claim 5, wherein the diffractive meta-surface flat optic is configured to scatter light at an angle that is a function of an angle of incidence of an optical beam illuminating the diffractive meta-surface flat optic.

8. The light detection and ranging transmitter of claim 1, wherein the flat optic element is configured to uniformly scatter optical beams generated by the plurality of lasers.

9. The light detection and ranging transmitter of claim 1, wherein the shapes of the optical beams are transformed to change spot sizes of the optical beams projected onto the target plane to achieve a desired optical pattern.

10. The light detection and ranging transmitter of claim 1, wherein the shape of the optical beams is transformed to improve a fill-factor provided by the optical beams at the target plane.

11. The light detection and ranging transmitter of claim 1, wherein the shape of the optical beams is transformed to split a beam into multiple beams in a desired pattern.

12. The light detection and ranging transmitter of claim 1, wherein the shape of the optical beams is transformed to be rectangular.

13. The light detection and ranging transmitter of claim 1, wherein the shape of the optical beams is transformed to be circular.

14. The light detection and ranging transmitter of claim 1, wherein an image plane of the target plane comprises a detector array.

15. A light detection and ranging transmitter comprising:
a) a laser array comprising a plurality of lasers, each of the plurality of lasers generating an optical beam at an output of the laser array;
b) a first transmission optic having a first focal length and being positioned adjacent to the output of the laser array, the first transmission optic projecting the optical beams generated by the laser array;
c) a second transmission optic having a second focal length and being positioned after the first transmission optic in a direction of propagation of the optical beams generated by the laser array, the second transmission optic projecting the optical beams generated by the laser array onto a target plane; and
d) a flat optic element positioned after the second transmission optic and before the target plane in the direction of propagation of the optical beams, wherein the flat optic element is configured to transform a shape of the optical beams generated by the plurality of lasers.

16. The light detection and ranging transmitter of claim 15, wherein the laser array comprises a vertical cavity surface emitting laser.

17. The light detection and ranging transmitter of claim 15, wherein the laser array comprises a two-dimensional vertical cavity surface emitting laser.

18. The light detection and ranging transmitter of claim 15, wherein the flat optic element comprises a meta-surface flat optic.

19. The light detection and ranging transmitter of claim 15, wherein the flat optic element comprises a diffractive meta-surface flat optic.

20. The light detection and ranging transmitter of claim 19, wherein the diffractive meta-surface flat optic comprises first periodic structure having features greater than a wavelength of light illuminating the first periodic structure and a second periodic structure having features less than a wavelength of light illuminating the second periodic structure.

21. The light detection and ranging transmitter of claim 19, wherein the diffractive meta-surface flat optic is configured to scatter light at an angle that is a function of an angle of incidence of an optical beam illuminating the diffractive meta-surface flat optic.

22. The light detection and ranging transmitter of claim 15, wherein the flat optic element is configured to uniformly scatter optical beams generated by the plurality of lasers.

23. The light detection and ranging transmitter of claim 15, wherein the shape of the optical beams is transformed to change spot sizes of the optical beams projected onto the target plane to achieve a desired optical pattern.

24. The light detection and ranging transmitter of claim 15, wherein the shape of the optical beams is transformed to improve a fill-factor of the beams on at the target plane.

25. The light detection and ranging transmitter of claim 15, wherein the shape of the optical beams is transformed to split a beam into multiple beams in a desired pattern.

26. The light detection and ranging transmitter of claim 15, wherein the shape of the optical beams is transformed to be rectangular.

27. The light detection and ranging transmitter of claim 15, wherein the shape of the optical beams is transformed to be circular.

28. The light detection and ranging transmitter of claim 15, wherein an image plane of the target plane comprises a detector array.

29. A light detection and ranging system comprising:
a) a laser array comprising a plurality of lasers, each of the plurality of lasers generating an optical beam at an output of the laser array;
b) a first transmission optic having a first focal length and being positioned adjacent to the output of the laser array, the first transmission optic projecting the optical beams generated by the laser array;
c) a flat optic element positioned between the output laser array and the first transmission optic, wherein the flat optic element is configured to transform a shape of the optical beams generated by the plurality of lasers;
d) a second transmission optic having a second focal length and being positioned after the first transmission optical in a direction of propagation of the optical beams, the second transmission optic projecting the optical beams with the transformed shape onto a target plane, wherein the first focal length, the second focal length, and the transformed shape of the optical beams are configured to achieve a desired optical pattern at the target plane; and
e) a detector array positioned at an image plane of the target plane.

30. The light detection and ranging transmitter of claim 29 where the detector array comprises a Single Photon Avalanche Detector (SPAD) array.

31. The light detection and ranging transmitter of claim 29 where the detector array comprises a Silicon Photomultiplier (SiPM) array.

32. The light detection and ranging transmitter of claim 29 wherein a number of pixels in the detector array is great than a number of transmitter sub-apertures in the laser array.

33. A light detection and ranging transmitter comprising:
a) a laser array comprising a plurality of lasers, each of the plurality of lasers generating an optical beam at an output of the laser array;
b) a first transmission optic having a first focal length and being positioned adjacent to the output of the laser array, the first transmission optic projecting the optical beams generated by the laser array;
c) a second transmission optic having a second focal length and being positioned after the first transmission optical in a direction of propagation of the optical beams generated by the laser array, the second transmission optic projecting the optical beams generated by the laser array with the transformed shape onto a target plane;
d) a flat optic element positioned after the second transmission optic and before the target plane in the direction of propagation of the optical beams, wherein the flat optic element is configured to transform a shape of the optical beams generated by the plurality of lasers; and
e) a detector array positioned at an image plane of the target plane.

34. The light detection and ranging transmitter of claim 33 where the detector array comprises a Single Photon Avalanche Detector (SPAD) array.

35. The light detection and ranging transmitter of claim 33 where the detector array comprises a Silicon Photomultiplier (SiPM) array.

36. The light detection and ranging transmitter of claim 33 wherein a number of pixels in the detector array is great than a number of transmitter sub-apertures in the laser array.
